(19) United States
(12) Patent Application Publication
(10) Pub. No.: US 2014/0017055 A1
(43) Pub. Date: Jan. 16, 2014

(54) MATERIAL REPLACEMENT DEVICE AND ELECTRONIC APPARATUS

(71) Applicants: HONG FU JIN PRECISION INDUSTRY (ShenZhen) CO., LTD., (US); HON HAI PRECISION INDUSTRY CO., LTD., New Taipei (TW)

(72) Inventors: Zhao-Yong LI, Shenzhen (CN); Lian-Gang XUE, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/847,502

(22) Filed: Mar. 20, 2013

(30) Foreign Application Priority Data
Jul. 11, 2012 (CN) 201210238681.6

(51) Int. Cl. G11B 17/00

(52) U.S. Cl. CPC G11B 17/00
USPC 414/744.8; 414/744.2

(57) ABSTRACT

An electronic apparatus for replacing materials for a device is mounted on a base. The electronic apparatus comprises an installing mechanism and a controlling mechanism for controlling the operations of the installing mechanism. The controlling mechanism can position materials on the device and can remove the materials from the device.

### BACKGROUND

1. Technical Field

The present disclosure relates to replacement material devices, and particularly to an electronic apparatus using a replacement material device.

2. Description of Related Art

Before leaving the factory, electronic devices, for example, computers and disc players, are tested by a plurality of testing discs, for investigating normal functions of the electronic devices. Typically, the technician manually takes a testing disc out of the electronic device after a testing process, and puts another testing disc into the electronic device for further testing. However, this manual procedure is time-consuming and complicated.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of an electronic apparatus having a replacement material device.

FIG. 2 is a partial, exploded view of the electronic apparatus of FIG. 1.

FIG. 3 is a partial, exploded view of the replacement material device of FIG. 2.

FIG. 4 is another partial, exploded view of the replacement material device of FIG. 2.

FIG. 5 is an isometric view of the electronic apparatus of FIG. 1 in a first state.

FIG. 6 is an isometric view of an electronic apparatus of FIG. 1 in a second state.

FIG. 7 is an isometric view of an electronic apparatus of FIG. 1 in a third state.

FIG. 8 is an isometric view of an electronic apparatus of FIG. 1 in a fourth state.

### DETAILED DESCRIPTION

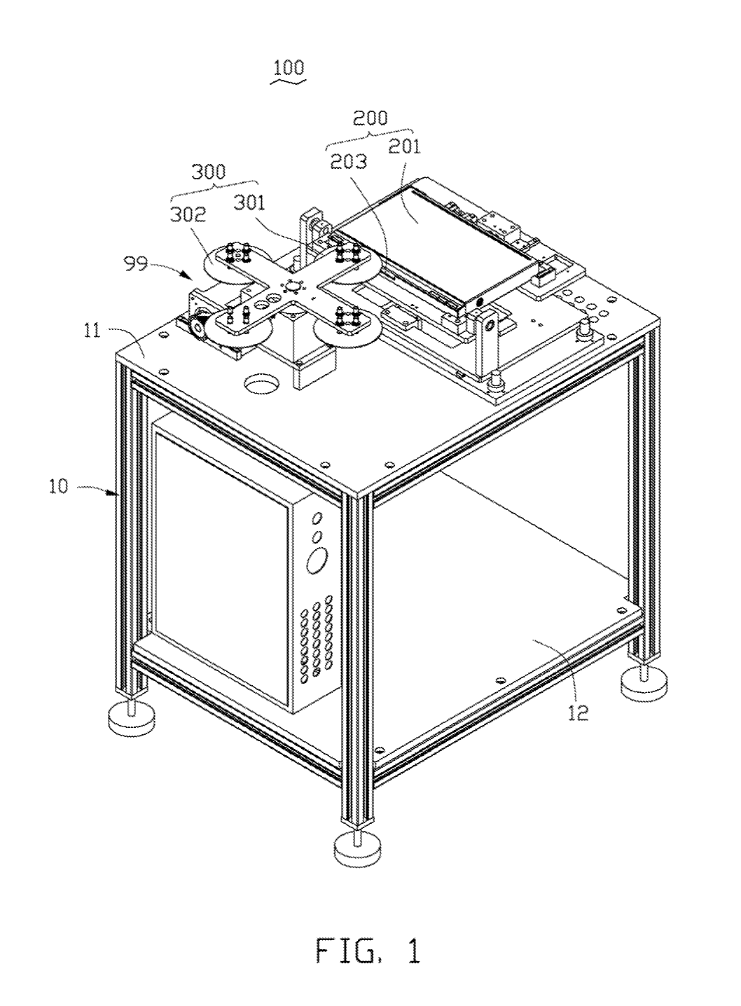

FIG. 1 shows an electronic apparatus 100 in accordance with an embodiment. The electronic apparatus 100 includes a base 10 and a replacement material device 99 mounted on the base 10. The replacement material device 99 is adapted to replace or reload materials 300 for a device 200. In the embodiment, the device 200 is a disc player. The device 200 includes a body 201 and a tray 203 slideably connected to the body 201. The body 201 is substantially rectangular, and has three interfaces (not shown) for allowing the disc player to be electrically connected to peripheral equipment. The materials 300 include a first material 301 and a second material 302. The first material 301 is a first testing disc for testing audio capabilities of the disc player. The second material 302 is a second testing disc for testing video capabilities of the disc player. The device 200 is capable of being switched between a working state and a waiting state. When the device 200 is in the working state, the tray 203 is closed relative to the body 201, and the first or second material 301 or 302 is received in the tray 203 for testing the device 200. When the device 200 is in the waiting state, the tray 203 is open relative to the body 201. In another embodiment, the device 200 may be a computer or other electronic device.

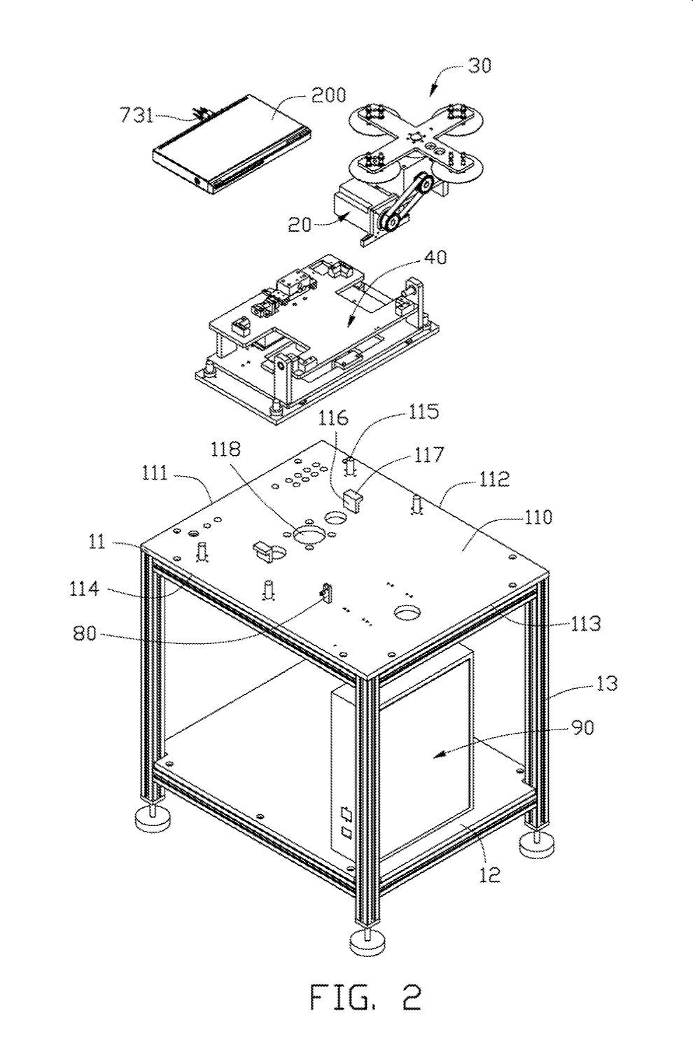

Referring also to FIG. 2, the base 10 includes a first placement stage 11 for mounting the replacement material device 99 and a second placement stage 12. The second placement stage 12 is spaced from the first placement stage 11 and is opposite to the replacement material device 99. When the base 10 is placed on a support surface (not shown), the second placement stage 12 is between the first placement stage 11 and the support surface.

The first placement stage 11 is substantially rectangular, and includes a first surface 110 opposite to the second placement stage 12, a first sidewall 111, a second sidewall 112, a third sidewall 113 opposite to the first sidewall 111, and a fourth sidewall 114 opposite to the second sidewall 112. Four guiding posts 115 protrude from the first surface 110. A line (not shown) interconnecting the guiding posts 115 forms a rectangular shape. Two hook-shaped preventing components 116 protrude from the first surface 110 and are arranged between the guiding posts 115. The preventing components 116 align in a direction parallel to the first sidewall 111, with two hook portions 117 opposite to each other. A first through hole 118 is defined between the preventing components 116.

The replacement material device 99 includes a driving mechanism 20, an installing mechanism 30, an operating mechanism 40, a sensor 80 and a controlling mechanism 90. The driving mechanism 20 is mounted on the first placement stage 11. The installing mechanism 30 is mounted on the driving mechanism 20 and is capable of being rotated by the driving mechanism 20. The operating mechanism 40 is mounted on the first placement stage 11, and moves the device 200 relative to the first placement stage 11. The sensor 80 detects whether the device 200 is in a waiting state or otherwise. In the embodiment, the sensor 80 detects when the tray 203 has been ejected out the body 201, and determines that the device 200 is in the waiting state if the tray 203 has been ejected out of the body 201. The controlling mechanism 90 controls the operations of the replacement material device 99.

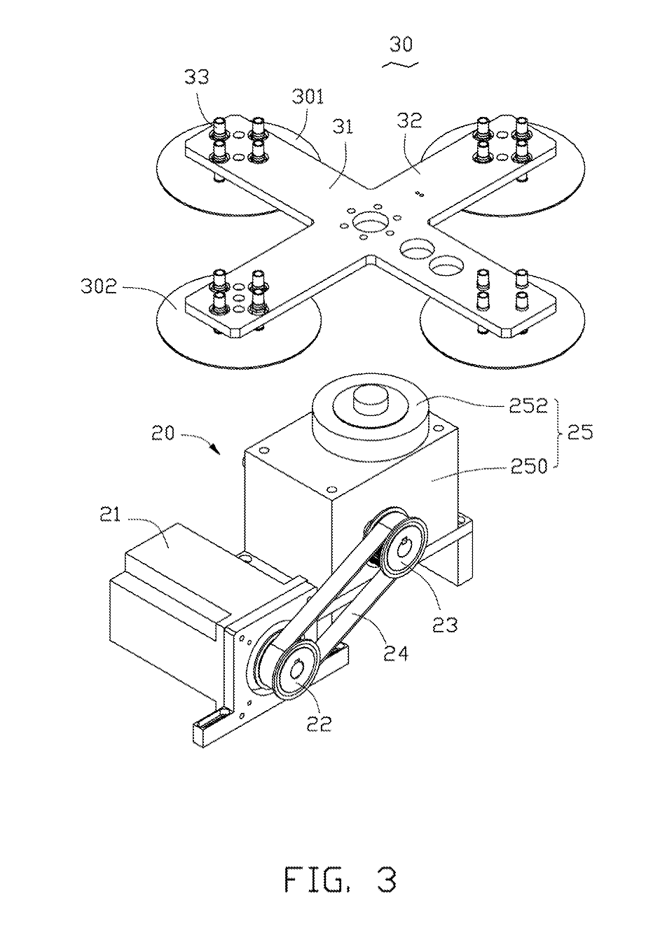

Referring to FIG. 3, the driving mechanism 20 is mounted on the first placement stage 11. The driving mechanism 20 includes a driving component 21, a drive wheel 22 connected to the driving component 21, a driven wheel 23, a belt 24 and a rotating component 25. In the embodiment, the driving component 21 is a motor. The driven wheel 23 is arranged on the rotating component 25 and connects with the drive wheel 22 via the belt 24. The rotating component 25 includes a fixing portion 250 and a shaft 252. The fixing portion 250 is positioned on the first placement stage 11. The shaft 252 is positioned on an end of the fixing portion 250 opposite to the first placement stage 11 and is capable of being driven to rotate relative to the fixing portion 250 by the driving component 21.

The installing mechanism 30 is substantially in the shape of a cross and is fixed to the shaft 252. The installing mechanism 30 includes a first fixing portion 31, a second fixing portion 32 and four sucking portions 33. The first fixing portion 31 and the second fixing portion 32 are perpendicular to each other. Two sucking portions 33 are arranged on opposite ends of the first fixing portion 31, and another two sucking portions 33 are arranged on opposite ends of the second fixing portion 32. Each sucking portion 33 includes four suckers for adhering and releasing the first material 301 and/or the second material 302. In the embodiment, the first material 301 is fixed on one sucking portion 33 of the first fixing portion 31. The second material 302 is fixed on one sucking portion 33 of the second fixing portion 33.

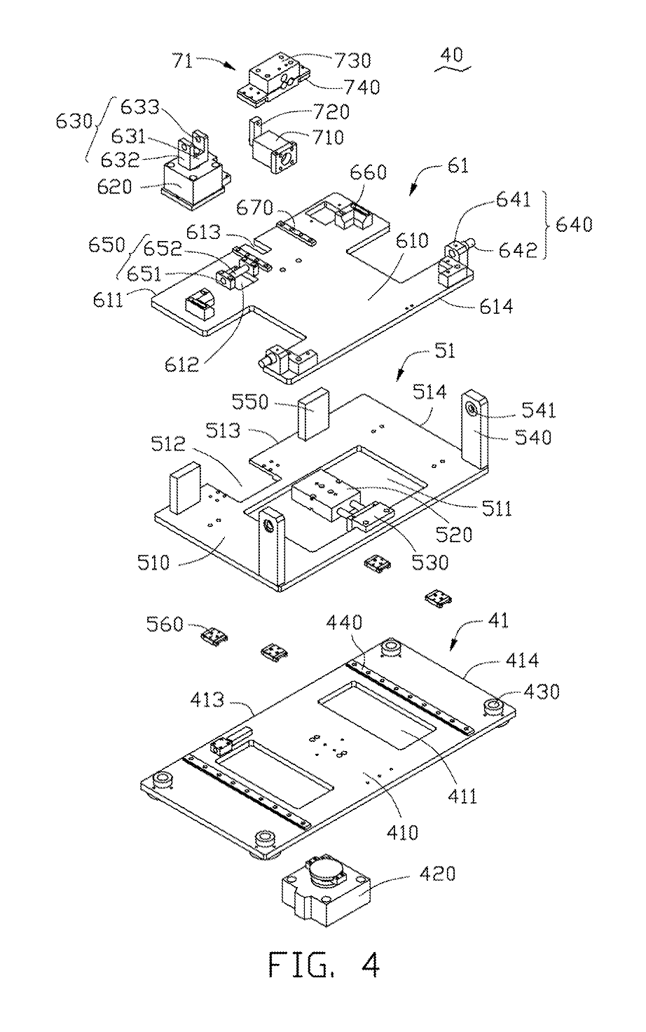

Referring to FIG. 4, the operating mechanism 40 is arranged on the first placement stage 11 and is opposite to the driving mechanism 20. The operating mechanism 40 includes an elevating module 41, a flexing module 51, an adjusting module 61 and an inserting module 71. The elevating module 41 is mounted on the first placement stage 11. The flexing module 51 is arranged between the elevating module 41 and the adjusting module 61. The adjusting module 61 is mounted on the flexing module 51. The inserting module 71 is arranged on the adjusting module 61.

The elevating module 41 includes a first fixing stage 410, a first cylinder 420, four first guiding components 430 and two first sliding rails 440. The first fixing stage 410 is substantially a rectangular plate, and includes a fifth sidewall 413 and a sixth sidewall 414 perpendicular to the fifth sidewall 413. The fifth sidewall 413 is parallel to, and corresponds to, the first sidewall 111. The sixth sidewall 414 is parallel to, and corresponds to, the second sidewall 112. The first fixing stage 410 defines two rectangular second through holes 411 corresponding to the two preventing components 116. An end of the first cylinder 420 passes through the first through hole 118 and is secured to a surface of the first fixing stage 410 opposite to the first placement stage 11, and another end of the first cylinder 420 is secured to a surface of the first placement stage 11 opposite to the second placement stage 12. The end of the first cylinder 420 secured to the first fixing stage 410 is capable of being moved in a direction perpendicular to the first placement stage 11. The first guiding components 430 are positioned on the first fixing stage 410 and correspond to the guiding posts 115. Each first sliding rail 440 is substantially a narrow strip, and is arranged between the corresponding first guiding component 430 and the second through hole 411 and is parallel to the sixth sidewall 414.

The flexing module 51 includes a second fixing stage 510, a second cylinder 520, a clamping component 530, two plate-shaped first connecting components 540, two plate-shaped supporting components 550, and four first sliding blocks 560. The second fixing stage 510 includes a seventh sidewall 513 and an eighth sidewall 514 perpendicular to the seventh sidewall 513. The seventh sidewall 513 corresponds to the fifth sidewall 413. The eighth sidewall 514 corresponds to the sixth sidewall 414. The second fixing stage 510 further defines a third through hole 511 and a first opening 512. The third through hole 511 is defined at the middle portion of the second fixing stage 510. The first opening 512 is recessed from a rim of the seventh sidewall 513. The clamping component 530 is coupled to a sidewall of the third through hole 511 and is parallel to the seventh sidewall 513. The second cylinder 520 is fixed to the first fixing stage 410 and is received in the third through hole 511. An end of the second cylinder 520 away from the seventh sidewall 513 is coupled to the clamping component 530, and is capable of being moved in a direction parallel to the first placement stage 11. The first connecting components 540 perpendicularly protrude from the second fixing stage 510 and are positioned on opposite ends of a sidewall of the second fixing stage 510 opposite to the seventh sidewall 513. Each first connecting component 540 defines a first pivoting hole 541. The supporting components 550 are positioned on opposite ends of the seventh sidewall 513. The height of the supporting components 550 is lower than that of the first connecting components 540. The first sliding blocks 560 are positioned on a surface of the second fixing stage 510 opposite to the first fixing stage 410. Two first sliding blocks 560 are collinear and correspond to one of the first sliding rails 440, and another two first sliding blocks 560 are collinear and correspond to another one of the first sliding rails 440. Thus, the second fixing stage 510 is capable of sliding relative to the first fixing stage 410.

The adjusting module 61 includes a third fixing stage 610, a third cylinder 620, a second connecting component 630, a first rotating portion 640, a second rotating portion 650, four positioning components 660, and two second sliding rails 670. The third fixing stage 610 includes a ninth sidewall 611 and a tenth sidewall 614. The ninth sidewall 611 corresponds to the seventh sidewall 513. The tenth sidewall 614 is opposite to the ninth sidewall 611. The third fixing stage 610 further defines a fourth through hole 612 and a second opening 613, all which are near to the ninth sidewall 611. The fourth through hole 612 corresponds to the first opening 512. The second opening 613 is recessed from a rim of the ninth sidewall 611. The second connecting component 630 is substantially U-shaped, and includes a body 631 and two arms 632 forming the uprights of the “U”. The two arms 632 protrude from opposite ends of the body 631 and each defines a second pivoting hole 633. The third cylinder 620 is arranged between the first fixing stage 410 and the third fixing stage 610 via the second connecting component 630. An end of the third cylinder 620 secured to the second connecting component 630 is capable of being moved in a direction perpendicular to the first placement stage 11.

The first rotating portions 640 are positioned on opposite ends of the third fixing stage 610 near the tenth sidewall 614. Each first rotating portion 640 includes a first connecting post 641 and a first pivot 642. The first connecting post 641 is positioned on the third fixing stage 610. The first pivot 642 protrudes from the first connecting post 641 in a direction away from the third fixing stage 610. The second rotating portion 650 is positioned on the third fixing stage 610 near the ninth sidewall 613 and above the fourth through hole 612. The second rotating portion 650 includes two second connecting posts 651 and a second pivot 652. The second connecting posts 651 are positioned on opposite sides of the fourth through hole 612 and are parallel to the ninth sidewall 611. The second pivot 652 connects each second connecting post 651. The four positioning components 660 are positioned on the four corners of the third fixing stage 610 and form a rectangle which corresponds to the body 201 of the device 200.

The inserting module 71 includes a fourth cylinder 710, a third connecting component 720, and an inserting component 730 and two sliding blocks 740. The fourth cylinder 710 is positioned on a surface of the third fixing stage 610 opposite to the second fixing stage 510. The inserting component 730 is connected to the fourth cylinder 710 via the third connecting component 720. The inserting component 730 defines three mounting holes 732 for mounting three signal wires 731 (see FIG. 2). The second sliding blocks 740 are arranged on opposite sides of the inserting component 730 and correspond to the second sliding rails 670.

The sensor 80 is arranged between the operating mechanism 40 and the driving mechanism 20. The controlling mechanism 90 is mounted on the second placement stage 12 for controlling the operation of the driving mechanism 20, the installing mechanism 30, and the operating mechanism 40. In detail, the controlling mechanism 90 controls the driving mechanism 20 to rotate the installing mechanism 30. Further, the controlling mechanism 90 controls the first cylinder 420 to drive the first fixing stage 410 back and forth in a first direction perpendicular to the first placement stage 11. The controlling mechanism 90 controls the second cylinder 520 to drive the second fixing stage 510 back and forth in a second direction parallel to the first fixing stage 410. The controlling mechanism 90 further controls the third cylinder 620 to drive an end of the third fixing stage 610 secured to the third cylinder 620 in the first direction perpendicular to the first placement stage 11. The controlling mechanism 90 further controls the fourth cylinder 710 to drive the inserting component 730 back and forth in the second direction. In the embodiment, the sensor 80 is a raster sensor.

In assembly, the first fixing stage 410 is positioned on the first placement stage 11 by virtue of the engagement between the first guiding components 430 and the guiding posts 115. The preventing components 116 extend through the second through holes 411. One end of the first cylinder 420 extends through the first through hole 118 and is secured to a surface of the first fixing stage 410 opposite to the first placement stage 11, and another end of the first cylinder 420 is secured to a surface of the first placement stage 11 opposite to the first fixing stage 410. Thus, the first fixing stage 410 is capable of being moved in the first direction perpendicular to the first placement stage 11 by virtue of the movement of the first cylinder 420, for adjusting the distance between the device 200 and the installing mechanism 30 in the first direction.

The second fixing stage 510 is slideably connected to the first fixing stage 410 via the first sliding blocks 560, with the first opening 512 facing the fifth sidewall 413. The second cylinder 520 is received in the third through hole 511 and is secured to the second fixing stage 510 via the clamping component 530. Thus, the second fixing stage 510 is capable of sliding relative to the first fixing stage 410 in the second direction parallel to the eighth sidewall 514 by virtue of the movement of the second cylinder 520, for aligning the device 200 with the installing mechanism 30.

One end of the third fixing stage 610 near the tenth sidewall 614 is rotatably connected to the second fixing stage 510 via the engagement between the first pivots 642 and the first connecting components 540, and another end of the third fixing stage 610 (near the ninth sidewall 611) is supported on the supporting components 550. The third cylinder 620 is positioned on the first fixing stage 410 and is received in the first opening 512. One end of the second connecting component 630 is secured to the third cylinder 620, and another end of the second connecting component 630 is rotatably connected to the second pivot 652. Thus, the end of the third fixing stage 610 near the ninth sidewall 611 is capable of moving in a direction perpendicular to the second fixing stage 510 via the movement of the third cylinder 620 and drives another end of the third fixing stage 610 (near the tenth sidewall 614) to rotate relative to the first connecting components 540, for adjusting the angle between the device 200 and the installing mechanism 30.

The fourth cylinder 710 is mounted on a surface of the third fixing stage 610 facing the second fixing stage 510. The third connecting component 720 is arranged between the fourth cylinder 710 and the inserting component 730 and is received in the second opening 613. The inserting module 71 slideably connects to the third fixing stage 610 via the second sliding blocks 740 and is driven to move in the second direction perpendicular to the first placement stage 11 by the movement of the fourth cylinder 710.

Before testing process, the first material 301 is sucked onto one sucking portion 33 of the first fixing portion 31. The second material 302 is sucked onto one sucking portion 33 of the second fixing portion 33. The device 200 is placed on the third fixing stage 610 and is restricted between the four positioning components 660. The signal wires 731 extend through the mounting hole 732 and are plugged into the interfaces of the device 200. After initial assembly, the first material 301 is adjacent to the device 200 (see FIG. 1).

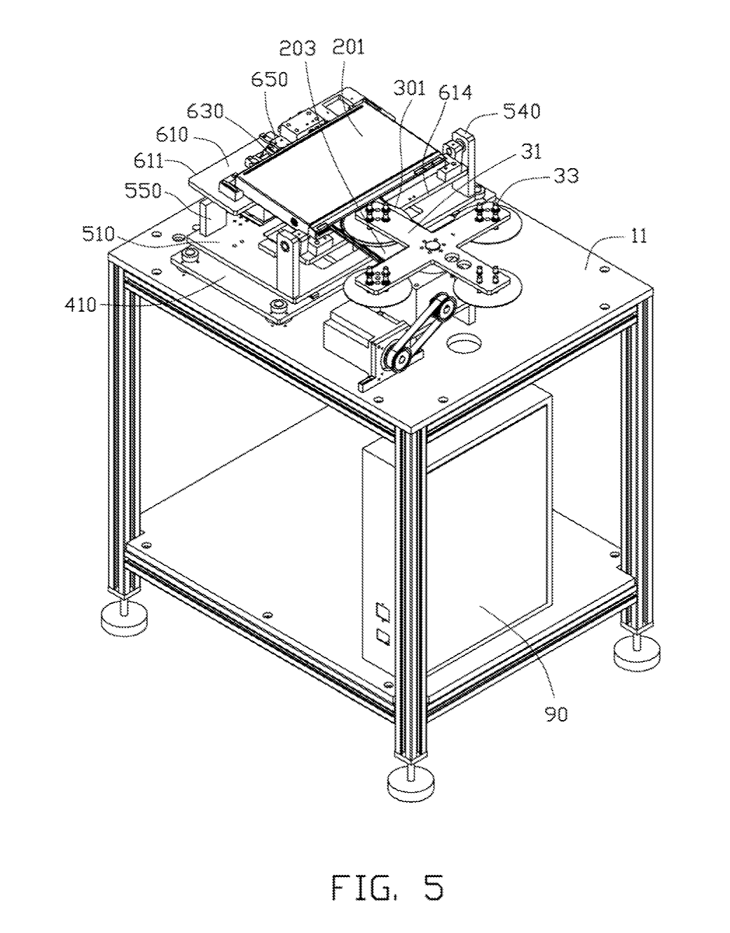

Referring to FIG. 5, in testing, the controlling mechanism 90 firstly controls the third cylinder 620 to raise an end of the third fixing stage 610 near the ninth sidewall 611. Thus, the second connecting component 630 rotates around the second rotating portion 650 and drives another end of the third fixing stage 610 near the tenth sidewall 614 to rotate relative to the fixing connecting components 540. In this state, the device 200 is downwardly inclined relative to the first fixing portion 11. In the embodiment, the rotating angle of the third fixing stage 610 is 5 degrees. The tray 203 is ejected out of the body 201 by the controlling mechanism 90. When the sensor 80 detects that the tray 203 has been ejected out of the body 201, the controlling mechanism 90 controls the first cylinder 420 to raise the first, the second and the third fixing stages, 410, 510 and 610, together in the first direction until the first fixing stage 410 resists the preventing components 116. Simultaneously, the controlling mechanism 90 controls the second cylinder 520 to drive the second and third fixing stages, 510, 610, to move toward the installing mechanism 30 in the second direction. Thus, the first material 301 is aligned with the tray 203, with a portion thereof received in the tray 203. Then, the sucking portion 33 of the first fixing portion 31 releases the first material 301 to allow the first material 301 to be received into the tray 203.

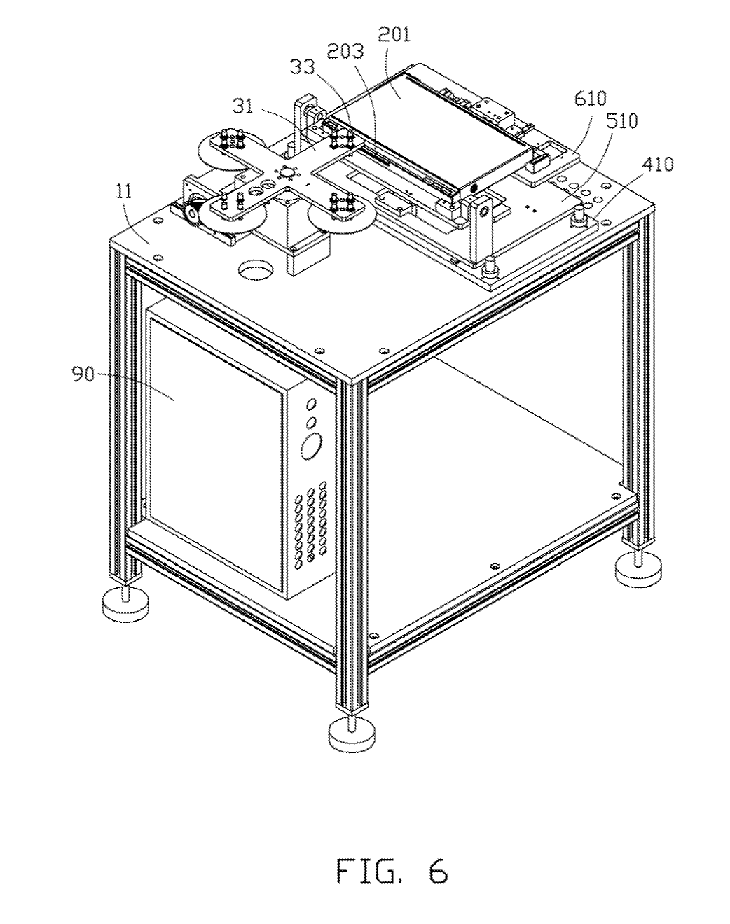

Referring to FIG. 6, the controlling mechanism 90 controls the first cylinder 420 to decline the first, second and third fixing stages 410, 510 and 610. The second and third fixing stages 510, 610 are driven to move away from the installing mechanism 30 by the second cylinder 520. The controlling mechanism 90 further controls the third cylinder 620 to drive an end of the third fixing stage 610 adjacent to the ninth sidewall 611 to move down. In this state, the third fixing stage 610 is parallel to the fixing placement stage 11. The controlling mechanism 90 retracts the tray 203 into the body 201, and the device 200 is then in the working state. Due to the first material 301 being deposited in the tray 203, the sucking portion 33 corresponding to the first material 301 is now vacant, for adhering the first material 301 again after the testing of the first material 301 has been finished.

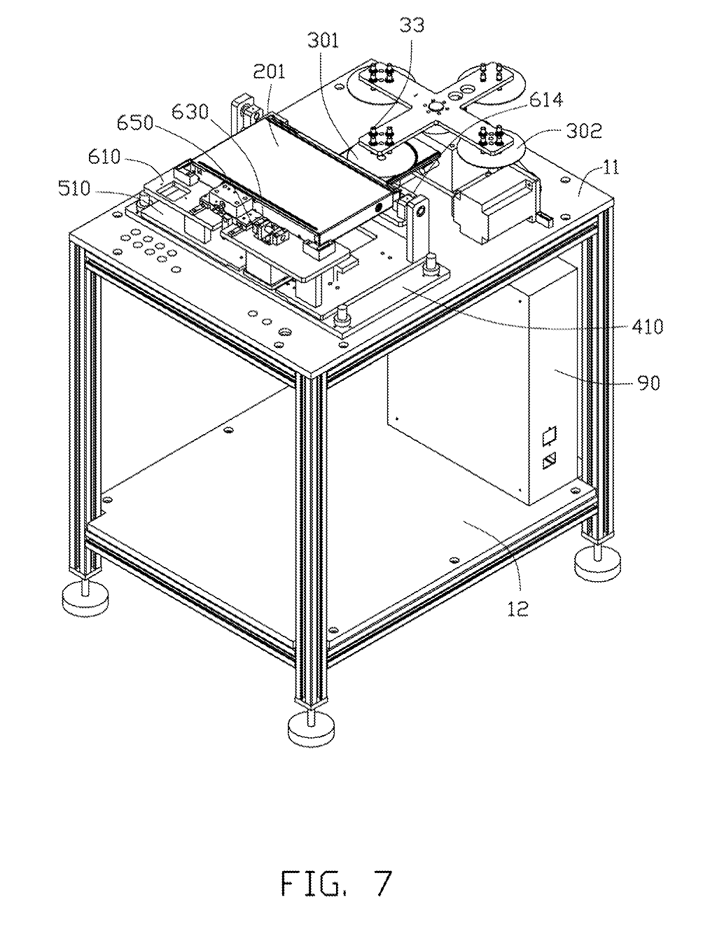

Referring to FIG. 7, after the testing of the first material 301 finished, the tray 203 opens relative to the body 201. The controlling mechanism 90 controls the third fixing stage 610 to rotate to the first placement stage 11. The controlling mechanism 90 controls the first, the second and the third fixing stages, 410, 510 and 610, to raise together relative to the first placement stage 11 and further controls the second and third fixing stages, 510, 610, to move toward the installing mechanism 30. Thus, the vacant sucking portion 33 is aligned with the first material 301 in the tray 203 and sucks the first material 301 back up from the tray 203 under the control of the external module.

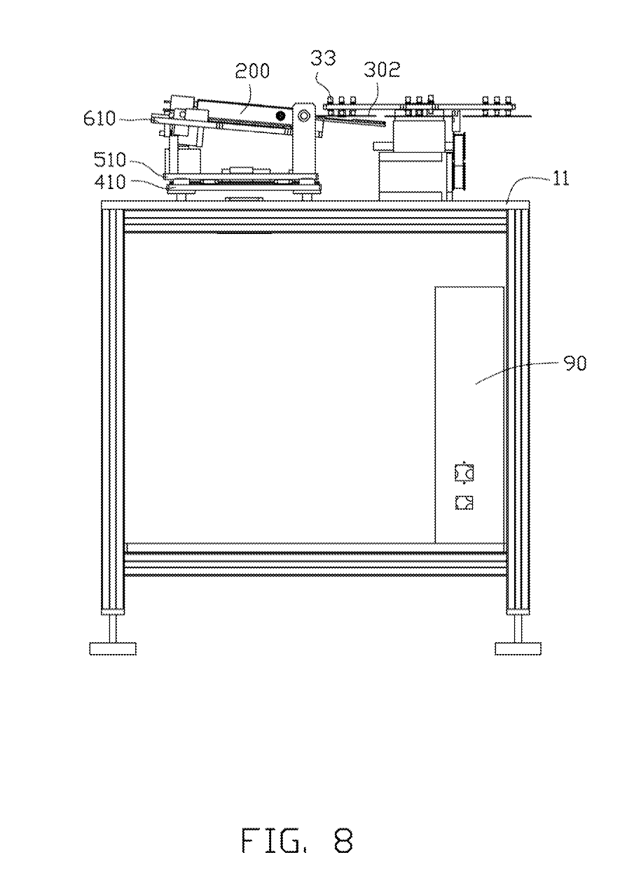

Referring to FIG. 8, when the sucking portion 33 has sucked the first material 301 back up, the controlling mechanism 90 controls the first, the second and the third fixing stages, 410, 510 and 610, to move down, and the second and third fixing stages, 510, 610, to move away from the installing mechanism 30. The installing mechanism 30 is rotated to the first placement stage 11, for allowing the second material 302 to be aligned with the tray 203. The controlling mechanism 90 then controls the first, the second and the third fixing stages, 410, 510 and 610, to rise together relative to the first placement stage 11. The controlling mechanism 90 controls the second and third fixing stages 510, 610 to move toward the installing mechanism 30. Then, the sucking portion 33 releases the second material 302 into the tray 203. When the tests of the second material 302 are complete, the replacement material device 99 repeats the above process to suck the second material 302 up from the tray 203.

The positions of the driving mechanism 20, the installing mechanism 30, the operating mechanism 40 and the controlling mechanism 90 can all be changed according to the position of the device 200, for example; the device 200 can be placed on the first placement stage 11 and permanently aligned with the installing mechanism 30. Thus, the operating mechanism 40 can be omitted.

Although information and the advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic apparatus, for replacing materials for a device, the electronic apparatus comprising:
a base for positioning the materials and the device; and
a replacement material device mounted on the base, the replacement material device comprising:
an installing mechanism mounted on the base for replacing the materials for the device; and
a controlling mechanism for controlling the operations of the installing mechanism;
wherein when the device is in a waiting state, the controlling mechanism is capable of driving the installing mechanism to position materials on the device and to remove materials from the device.

2. The electronic apparatus as claimed in claim 1, wherein the materials comprises a first material and a second material, the installing mechanism comprises at least two sucking portions for adhering and releasing the first and second materials; the installing mechanism is capable of being rotated to align one of the sucking portions with the device for allowing the material adhering to the sucking portion to being placed on and removed from the device.

3. The electronic apparatus as claimed in claim 2, wherein the replacement material comprises a driving mechanism mounted on the base, the driving mechanism drives the installing mechanism to rotate for aligning one of the sucking portions with the device.

4. The electronic apparatus as claimed in claim 1, wherein the replacement material device comprises an operating mechanism mounted on the base, the operating mechanism supports the device and is capable of being rotated relative to the base for rotating the device to be slanted to the base.

5. The electronic apparatus as claimed in claim 4, wherein the operating mechanism is capable of being moved in a first direction perpendicular to the base to adjust the distance between the device and the installing mechanism.

6. The electronic apparatus as claimed in claim 5, wherein the operating mechanism is capable of being moved in a second direction parallel to the base for aligning the device with the installing mechanism.

7. The electronic apparatus as claimed in claim 6, wherein a first guiding post protrudes from the base; the operating mechanism comprises a first fixing stage parallel to the base, a first cylinder and a first guiding component engaged with the first guiding post; the fixing stage is capable of being moved in a first direction perpendicular to the base along the first guiding post by the first cylinder for adjusting the distance between the device and the installing mechanism.

8. The electronic apparatus as claimed in claim 7, wherein a first sliding rail is mounted on the base; the operating mechanism comprises a second fixing stage parallel to the first fixing stage, a second cylinder and a first sliding block corresponding to the first sliding rail; the second fixing stage is capable of being slid in a second direction parallel to the base along the first sliding rail by the second guiding cylinder for aligning the device with the installing mechanism.

9. The electronic apparatus as claimed in claim 8, wherein a first connecting component is mounted on the second fixing stage; the operating mechanism comprises a third fixing stage parallel to the second fixing stage, a third cylinder and a first rotating portion engaging with the first connecting component, the device is placed on the third fixing stage; the third fixing stage is capable of being rotated relative to the first rotating portion by the third cylinder for rotating the device to be slanted to the base.

10. The electronic apparatus as claimed in claim 9, wherein the operating mechanism further comprises a second connecting component and a second rotating portion, the second connecting component is arranged between the third cylinder and the second rotating portion; the third cylinder drives the first connecting component to rotate around the first rotating portion for driving the device placed on the third fixing stage to be slanted to the base.

11. The electronic apparatus as claimed in claim 1, wherein the first and second materials are testing discs for testing the device, the device comprises a body and a tray slideably connected to the body; when the device is in the waiting state, the tray opens to load the first or second testing discs.

12. The electronic apparatus as claimed in claim 1, wherein the replacement material comprises a sensor for detecting whether the device is in the waiting state.

13. A replacement material device, for replacing materials for a device, the replacement material device mounted on a base and comprising:
an installing mechanism mounted on the base for replacing the materials for the device; and
a controlling mechanism for controlling the operations of the installing mechanism;
wherein when the device is in a waiting state, the controlling mechanism is capable of driving the installing mechanism to position materials on the device and to remove materials from the device.

14. The replacement material device as claimed in claim 13, wherein the materials comprises a first material and a second material, the replacement material device comprises at least two sucking portions for adhering and releasing the first and second materials; the installing mechanism is capable of being rotated to align one of the sucking portions with the device for allowing the material adhering to the sucking portion to being placed on and removed from the device.

15. The replacement material device as claimed in claim 13, wherein the replacement material device comprises an operating mechanism mounted on the base, the operating mechanism supports the device and is capable of being rotated relative to the base for rotating the device to be slanted to the base.

16. The replacement material device as claimed in claim 15, wherein the operating mechanism is capable of being moved in a first direction perpendicular to the base to adjust the distance between the device and the installing mechanism, and is further capable of being moved in a second direction perpendicular to the first direction for aligning the device with the installing mechanism.

17. The replacement material device as claimed in claim 16, wherein a first guiding post protrudes from the base; the operating mechanism comprises a first fixing stage parallel to the base, a first cylinder and a first guiding component engaged with the first guiding post; the fixing stage is capable of being moved in a first direction perpendicular to the base along the first guiding post by the first cylinder for adjusting the distance between the device and the installing mechanism.

18. The replacement material device as claimed in claim 17, wherein a first sliding rail is mounted on the base; the operating mechanism comprises a second fixing stage parallel to the first fixing stage, a second cylinder and a first sliding block corresponding to the first sliding rail; the second fixing stage is capable of being slid in a second direction parallel to the base along the first sliding rail by the second guiding cylinder for aligning the device with the installing mechanism.

19. The replacement material device as claimed in claim 18, wherein a first connecting component is mounted on the second fixing stage; the operating mechanism comprises a third fixing stage parallel to the second fixing stage, a third cylinder and a first rotating portion engaging with the first connecting component, the device is placed on the third fixing stage; the third fixing stage is capable of being rotated relative to the first rotating portion by the third cylinder for rotating the device to be slanted to the base.

20. The replacement material device as claimed in claim 13, wherein further comprises a sensor for detecting whether the device is in the waiting state.
